(19) United States
(12) Patent Application Publication
(10) Pub. No.: US 2005/0193155 A1
(43) Pub. Date: Sep. 1, 2005

(54) Data transfer apparatus and transfer control program

(75) Inventor: Koji Fujita, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/928,129

(22) Filed: Aug. 30, 2004

(30) Foreign Application Priority Data
Feb. 26, 2004 (JP) 2004-052388

(51) Int. Cl. G06F 13/00

(52) U.S. Cl. 710/111; 710/113

(57) ABSTRACT

Based on an arbitration result on a plurality of data transfer requests, a transfer apparatus for performing data transfer using a data transfer path includes a first transfer request unit for requesting data transfer, a second transfer request unit for requesting data transfer shorter in transfer time than the data transfer of the first transfer request unit, and a transfer arbitration unit for prioritizing the second transfer request unit to transfer data using a data transfer path when a request from the second transfer request unit is detected.

### BACKGROUND OF THE INVENTION

1. Field of the Invention

The present invention relates to a data transfer system, and more specifically to a data transfer apparatus for processing a plurality of data transfer requests on a data transfer path, for example, a common bus, and a transfer control program therefor.

2. Description of the Related Art

When data transfer requests from a plurality of data transfer requesters are simultaneously issued to a data transfer path, for example, a common bus, it is necessary to arbitrate the plurality of transfer requests by so-called bus arbitration.

In a common bus protocol, a transfer burst length, for example, the length of data possibly transferred in an actual bus dedicated time after the arbitration is expanded, thereby reducing the effect of the wait time in an address cycle, etc. not used in the actual data transfer, and improving the bus use efficiency.

However, data transfer requests from other requesters cannot be received until the end of the burst transfer, and the wait time of other requesters is increased. If the wait time largely affects the performance of the system, there occurs the problem that the performance of the entire system is degraded.

On the other hand, the wait time of requesters can be maintained within a predetermined time by reducing the maximum transfer burst length. In this case, there occurs the problem that the throughput of the data transfer is degraded.

Japanese Patent Application Laid-open No. Hei 1-206446 “Common Bus Control System”, Japanese Patent Application Laid-open No. Hei 5-134980 “Bus System, and Japanese Patent Application Laid-open No. Hei 8-185371 “Bus Arbitration Apparatus” relate to the arbitration of a data transfer through a bus, and disclose the technology of the data transfer using a bus based on a priority. For example, Japanese Patent Application Laid-open No. Hei 8-185371 discloses the technology of prioritizing the data transfer between the CPU and an external device when the data transfer between external devices and the data transfer between the CPU and an external device run into conflict.

Japanese Patent Application Laid-open No. Hei 9-259071 “Communication Control Apparatus” discloses the technology of prioritizing the bus right request of the second DMA controller channel having a higher priority than the first DMA controller channel in the DMA data transfer through a data bus between the transmitter, the receiver, a memory device, and the transmitter/receiver and between the transmitter/receiver and the memory device.

Japanese Patent Application Laid-open No. Hei 11-143812 “DMA Circuit” discloses the transfer interrupt technology of forcibly interrupting a permission already given by a permission circuit to any DMA controller during the transfer in a data transfer using a plurality of channels.

Japanese Patent Application Laid-open No. 2001-75917 “DMA Transfer Apparatus and Image Decoding Apparatus” and Japanese Patent Application Laid-open No. 2003-256359 “Data Transfer Control Apparatus and Method” disclose the technology of arbitrating a conflict based on the priority. For example, Japanese Patent Application Laid-open No. 2001-75917 discloses a transfer device for easily improving the effect of a real time data transfer by assigning a higher priority channel to a data transfer under strict time restrictions.

However, in the technology of the above-mentioned literature, there is still the problem that the data transfer efficiency cannot be improved in the entire system by arbitrating requests when there occurs a conflict between the data transfer requests from a requester requiring a long data transfer time for a transfer of a large amount of data and a requester requiring a short data transfer time for a transfer of a relatively small amount of data.

### SUMMARY OF THE INVENTION

The present invention has been developed to solve the above-mentioned problems, and aims at improving the data transfer efficiency of the entire system by accepting a request of a requester which is transferring a larger amount of data after prioritizing a data transfer request having a shorter transfer time through a data transfer path when a conflict occurs between a data transfer request of a requester which is transferring a large amount of data and a data transfer request of a requester which is transferring a relatively small amount of data.

The data transfer apparatus according to the present invention arbitrates a plurality of data transfer requests, and transfers data through a data transfer path based on an arbitration result, and includes a first transfer request unit for requesting a data transfer, a second transfer request unit for requesting a data transfer shorter in transfer time than the first data transfer request, and a transfer arbitration unit for, when a data transfer request from the second transfer request unit is detected, prioritizing the transfer request from the second transfer request unit over the transfer request from the first transfer request, and allowing the second transfer request unit to transfer data through a data transfer path.

The first transfer request unit requests a data transfer. The second transfer request unit requests a data transfer shorter in transfer time than the data transfer requested by the first transfer request unit. When a data transfer request from the second transfer request unit is detected, the transfer arbitration unit accepts a data transfer request from the second transfer request unit, that is, the unit requesting a data transfer shorter in transfer time using a data transfer path.

In an embodiment of the present invention, when the first transfer request unit outputs an urgent signal indicating an urgent transfer request, the transfer arbitration unit can allow the first transfer request unit to be prioritized in transferring data using a data transfer path during the output period of the urgent signal. Otherwise, the transfer arbitration unit can equally allow the first transfer request unit and the second transfer request unit to transfer data using a data transfer path in, for example, the round robin system.

Furthermore, in an embodiment of the present invention, the data transfer apparatus can further include a third transfer request unit for requesting a data transfer shorter in transfer time than the data transfer of the first transfer request unit so that, when the data transfer requests from the first, second and third transfer request units run into a conflict, the transfer arbitration unit can equally allow the second and third transfer request unit to transfer data using a data transfer path in, for example, the round robin system, and can allow the first transfer request unit to transfer data using a data transfer path after the second and third transfer request unit complete the data transfer.

Next, the data transfer control according to the present invention is a program used by a computer to arbitrate a conflict between the first transfer request using a data transfer request and the second transfer request shorter in transfer time than the first transfer request, and allows the computer to perform the steps of detecting the second data transfer request, and transferring data by prioritizing the second transfer request over the first transfer request when the second transfer request is detected. In the embodiment, a data transfer control method similar to the program can also be used.

### BRIEF DESCRIPTION OF THE DRAWINGS

FIG. 1 is a block diagram showing the configuration according to the principle of the data transfer apparatus of the present invention;

FIG. 2 is a block diagram showing the basic configuration of the data transfer apparatus according to an embodiment of the present invention;

FIG. 3 is a time chart of a practical example of bus arbitration shown in FIG. 2;

FIG. 4 is a time chart of a practical example of bus arbitration when an EMRG signal is asserted;

FIG. 5 shows an example of the configuration of a bus arbiter;

FIG. 6 is a flowchart of the bus arbitration process (1);

FIG. 7 is a flowchart of the bus arbitration process (2);

FIG. 8 is a flowchart of the bus arbitration process (3);

FIG. 9 shows an example of the configuration of a generation and transmission circuit of a network transmission packet;

FIG. 10 is a time chart of an example (1) of a data transfer shown in FIG. 9;

FIG. 11 is a time chart of an example (2) of a data transfer shown in FIG. 9;

FIG. 12 shows the explanation of a method of storing transfer data by the address determination shown in FIG. 9;

FIG. 13 is a flowchart of the process of a DMA controller; and

FIG. 14 shows the explanation of the EMRG signal output system from the DMA controller.

### DESCRIPTION OF THE PREFERRED EMBODIMENTS

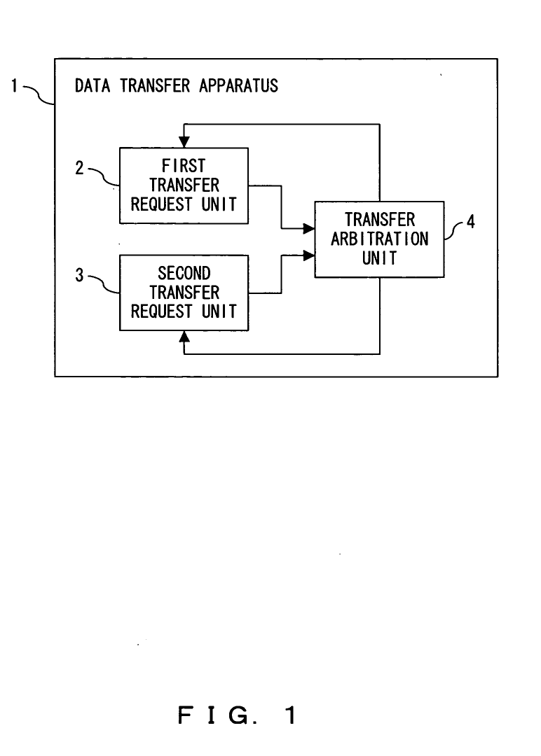

FIG. 1 is a block diagram showing the configuration according to the principle of the data transfer apparatus of the present invention. FIG. 1 is a block diagram showing the configuration according to the principle of the data transfer apparatus for arbitrating a plurality of data transfer requests, and allowing a data transfer using a data transfer path, for example, a common bus based on the result of the arbitration. A data transfer apparatus 1 comprises at least a first transfer request unit 2, a second transfer request unit 3, and a transfer arbitration unit 4.

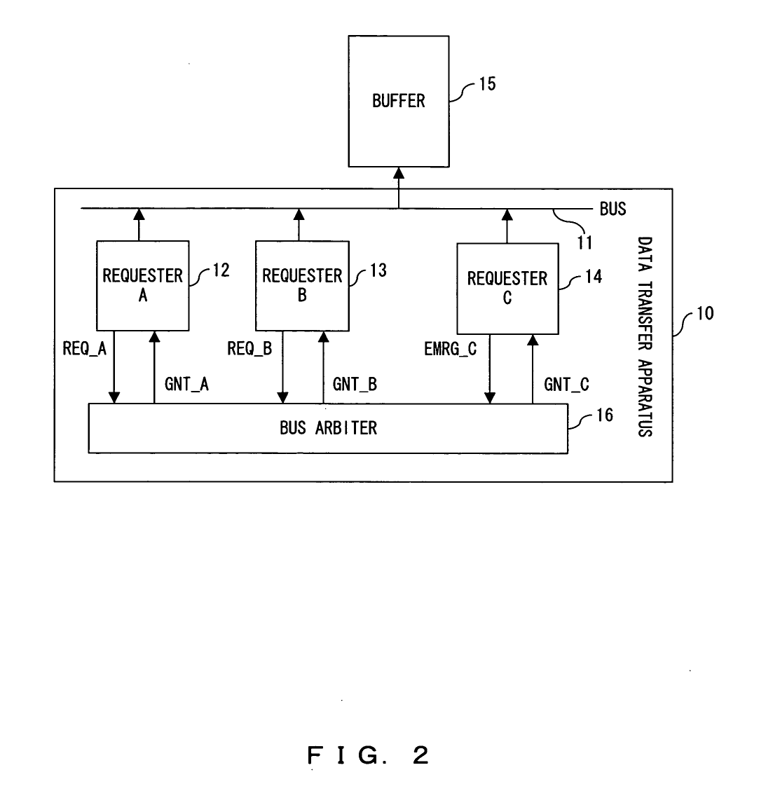

FIG. 2 is a block diagram showing the basic configuration of the data transfer apparatus according to an embodiment of the present invention. A data transfer apparatus 10 transfers data to a buffer 15 through a bus 11. A requester for requesting a data transfer can be requesters A12, B13, and C14. Among these three requesters, the bus 11 is used by the arbitration of a bus arbiter 16.

In FIG. 2, the requesters A and B transfer a relatively small amount of data to the buffer 15, and request for a shorter wait time for a transfer. On the other hand, the requester C writes a large amount of data to the buffer 15, and requests high throughput. The requesters A and B assert a REQ (request) signal with the timing they request the bus 11 to be acquired, continue asserting the REQ signal until a GNT (grant) signal from the bus arbiter 16 is asserted, deassert the REQ signal in the cycle in which the GNT signal is asserted, and transfer data while the GNT signal is asserted.

The bus arbiter 16 performs arbitration in, for example, the round robin system according to the REQ signal from the requesters A and B. As a result, it asserts either GNT_A or GNT_B. The bus arbiter 16 constantly asserts GNT_C in the cycle in which the GNT signals to the requesters A and B are not asserted.

The requester C determines that the bus 11 is available while the GNT_C is being asserted, and data is transferred when there is transfer data. When GNT_C is deasserted by the bus arbiter 16 during the data transfer, the data transfer is interrupted in the cycle, and the data transfer is resumed when GNT_C is asserted again.

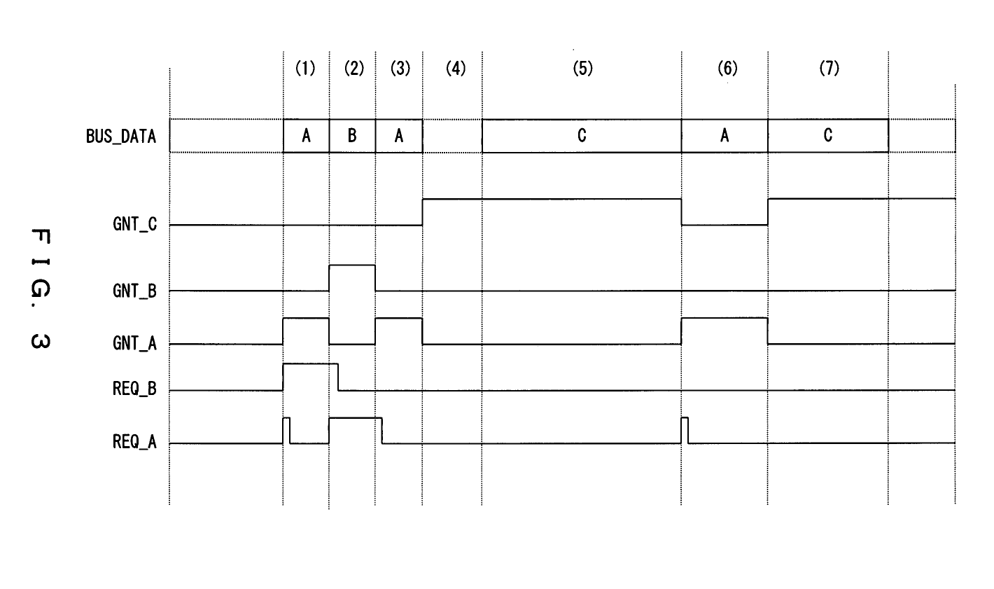

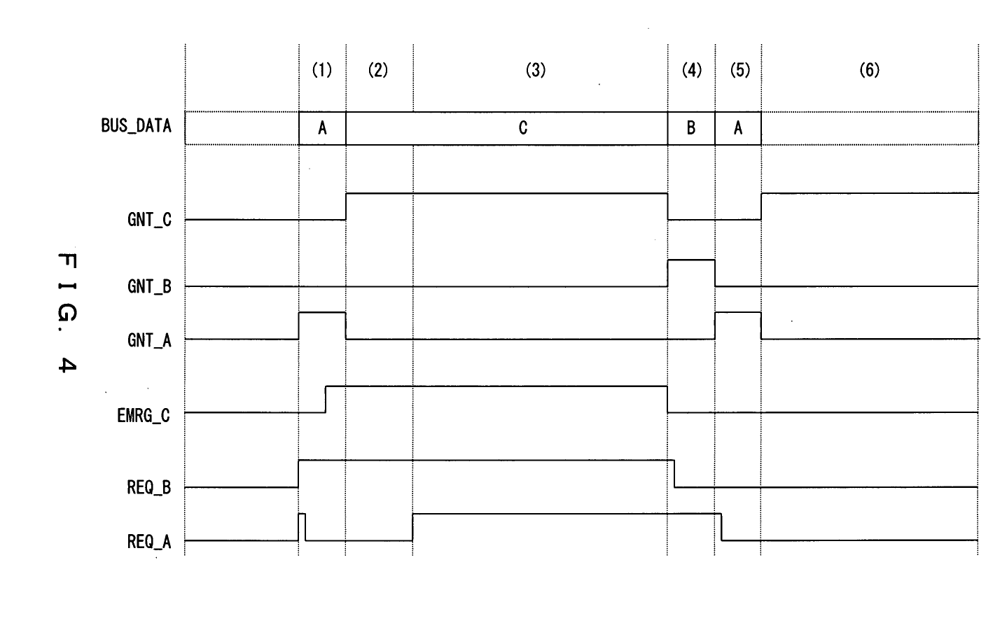

FIG. 3 is a time chart of a practical example of bus. In FIG. 3, the following process is performed. In FIGS. 3 and 4, the bus arbiter controls the assertion period of the GNT signal, that is, the transfer burst length in the time chart.
(1) The arbitration is performed between the requesters A and B, and the requester A acquires the bus and transfers data.
(2) The arbitration is performed between the requesters A and B, and the requester B acquires the bus and transfers data.
(3) Since only the requester A asserts the REQ signal, the requester A unconditionally acquires the bus, and transfers data.
(4) Since the requesters A and B are not using the bus, that is, since GNT_A and GNT_B are not being asserted, GNT_C is asserted.
(5) Since GNT_C is asserted with the timing the requester C requests data transfer, the data transfer is performed.

GNT_A is asserted at the request from the requester A, and GNT_C is deasserted. The requester C aborts the data transfer halfway.
(6) Only the requester A asserts the REQ signal, the requester A unconditionally acquires the bus, and performs the data transfer. In this case, the assertion period of the GNT signal for the data transfer of the requester A is longer than the period requested by the requester B as described in (1) above.
(7) Since the requesters A and B are not using the bus, that is, since GNT_A and GNT_B are not being asserted, GNT_C is asserted.

The requester C resumes the data transfer interrupted as described in (5) above, and completes the data transfer.

In FIG. 2, when the requester C has data to be urgently transferred, the EMRG_C signal is asserted. The bus arbiter 16 asserts GNT_C with the next arbitration timing, for example, in the next cycle, permits the requester C to use the bus 11 until EMRG_C is deasserted, and the normal arbitration is regained when EMRG_C is deasserted.

FIG. 4 is a time chart of a practical example of a bus arbitration when the EMRG signal is asserted. In FIG. 4, the following process is performed.
(1) The arbitration is performed between the requesters A and B, and the requester A acquires the bus and transfers data.
(2), (3) Since EMRG_C is asserted with the bus arbitration timing, GNT_C C is asserted. Since GNT_C is being asserted, the requester C transfers data.
(4) Since the requester C deasserts EMRG_C, the normal arbitration is regained, the requester B acquires the bus, and performs the data transfer.
(5) and (6) are omitted.

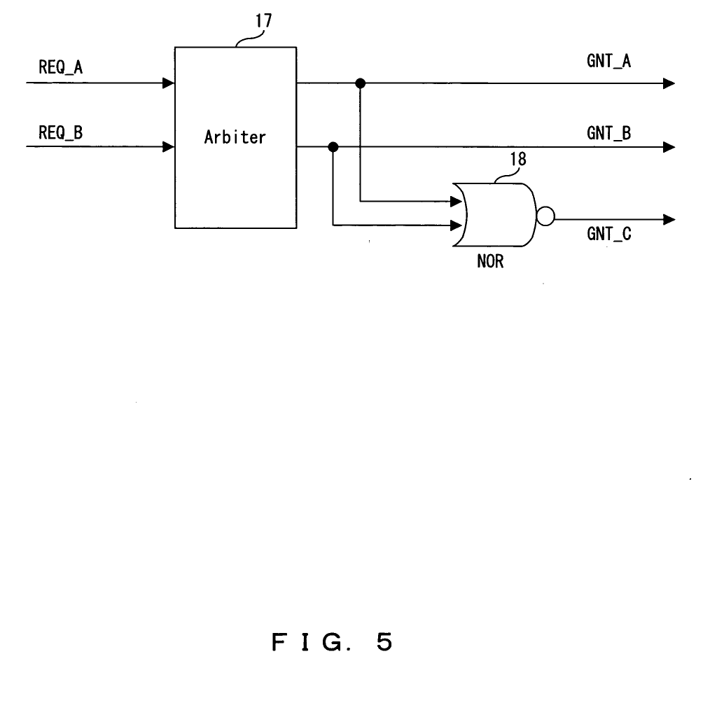

FIG. 5 shows an example of the configuration of the bus arbiter shown in FIG. 2. FIG. 5 shows the arbitration according to the time chart shown in FIG. 3. An arbiter 17 arbitrates in, for example, the round robin system according to the REQ_A or REQ_B signal, and asserts GNT_A or GNT_B. These signals are input to a NOR gate 18 so that the GNT_C signal is asserted when the two GNT signals are not being output. That is, the requester C which performs a transfer of a large amount of data is rejected from the arbitration, and the data transfer of the requester C is permitted only when the requester A or B is not using the bus.

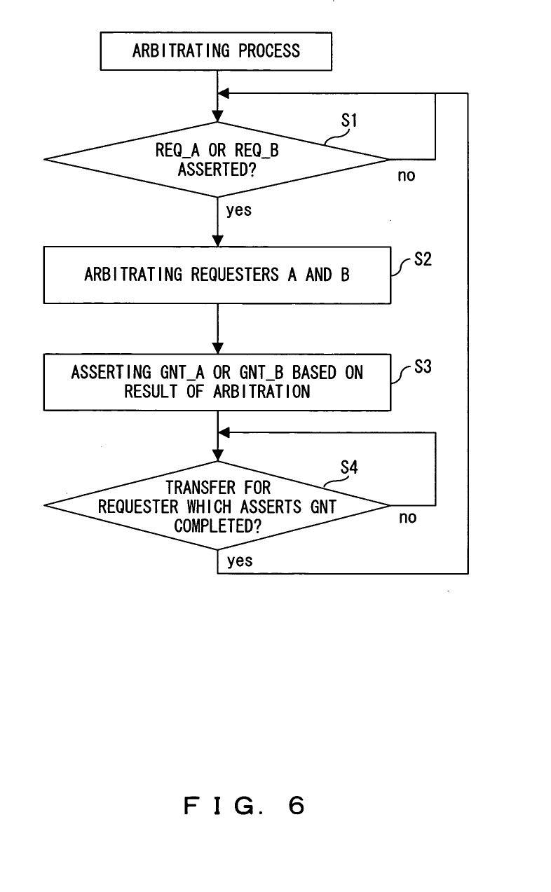

FIG. 6 is a flowchart of the arbitration process performed by the arbiter 17 shown in FIG. 5. In FIG. 6, it is determined in step S1 which is being asserted between the two REQ signals. If no signal is asserted, the monitor is continued. When the signals are asserted, the arbitration on the data transfer requests of the requesters A and B is performed in step S2, the GNT signal to the requester A or B is asserted based on the result in step S3, and it is determined whether or not the data transfer by the requester whose GNT signal has been asserted has been completed in step S4. If it has not been completed, the completion of the transfer is continuously monitored. If it has been completed, then the processes in and after step S1 are continued. That is, unlike in FIGS. 3 and 4, after the transfer of data of the amount smaller than a predetermined maximum burst size of data transfer is performed by a requester whose GNT signal has been asserted, the bus arbitration is performed again.

The determination of the completion of data transfer in step S4 can be made in various methods depending on the bus protocol, etc. The methods can be realized by, for example, first notifying the arbiter of the burst size of a data transfer, counting a burst cycle by the arbiter, and determining the completion of a data transfer when the data of the burst size has been transferred, and second asserting a dedicated data transfer completion signal by a requester and transmitting it to the arbiter, thereby completing the data transfer, etc.

Then, as explained by referring to FIG. 4, when the EMRG_C signal can be input to the arbiter, the GNT_C signal is continuously asserted while the EMRG signal is being asserted without assertion of the GNT_A signal and the GNT_B signal although the REQ_A signal or the REQ_B signal are asserted.

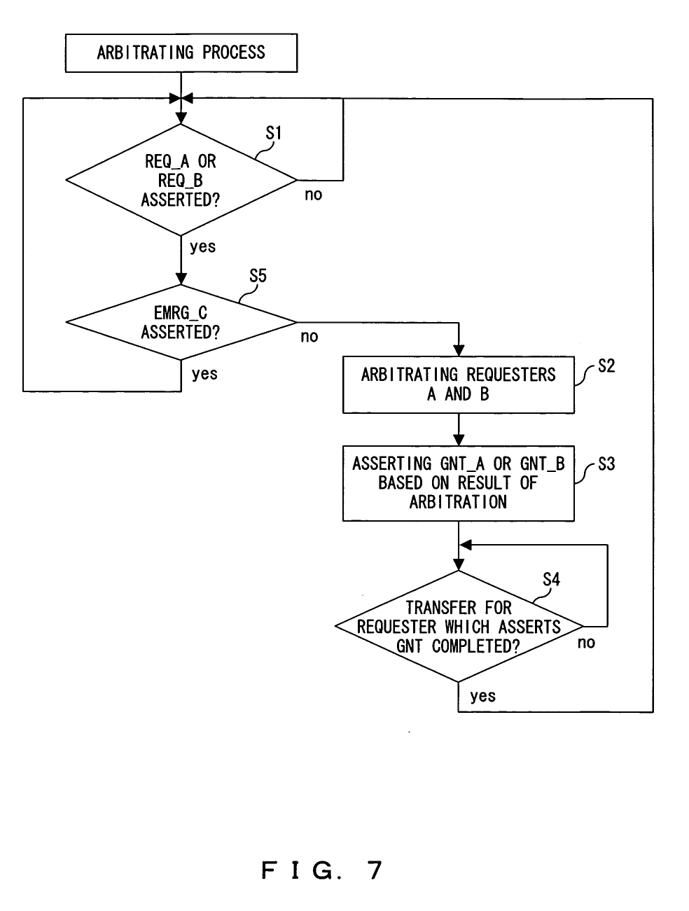

FIG. 7 is a flowchart of the arbitration process in this case. FIG. 7 is similar to the flowchart of the process shown in FIG. 6. However, when any of the two REQ signals is asserted in step S1, it is determined in step S5 before the process in step S2 whether or not the EMRG_C signal is being asserted. If it is not asserted, the processes in and after step S2 are performed as in FIG. 6. If it is asserted, then the processes in and after step S1 are continued without performing any process. That is, when the EMRG_C signal is asserted, the arbitration on the requesters A and B is not performed, the GNT_A signal and the GNT_B signal are not asserted, but the GNT_C signal is asserted, and the data transfer for the requester C is permitted.

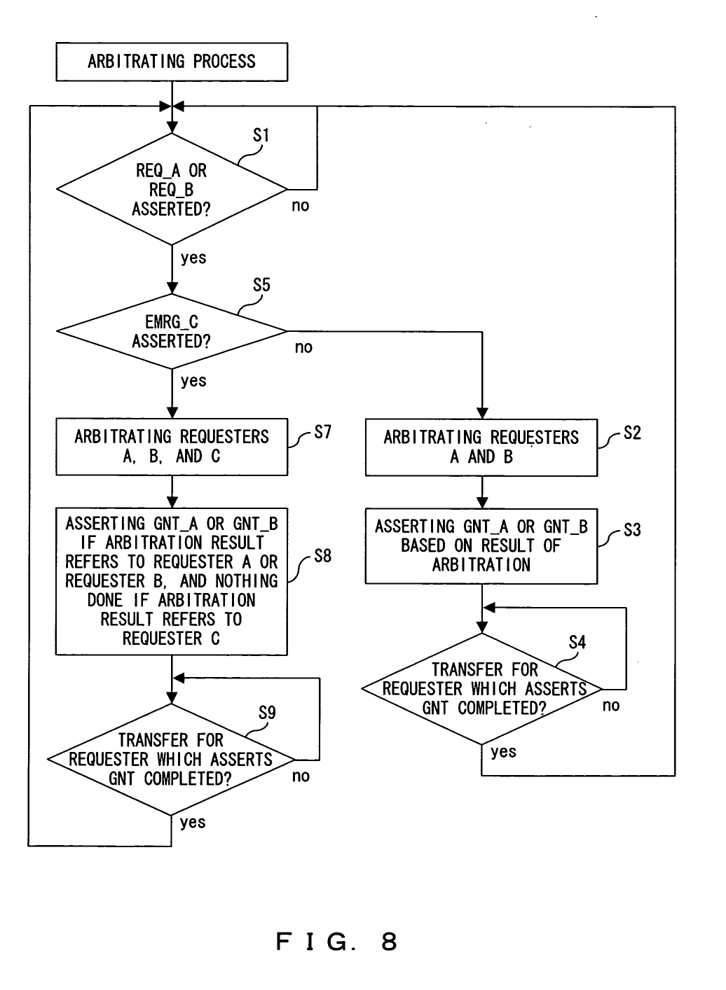

FIG. 8 is a flowchart of the arbitration process in which the data transfer requests from the three requesters A, B, and C are equally arbitrated when the requester C asserts the EMRG_C signal. In FIG. 8, the processes in steps S1, S5, and S2 through S4 are the same as those in FIG. 7, but when the EMRG_C signal is asserted in step S5, the process of equally arbitrating the data transfer requests from the three requesters A, B, and C is performed in step S7. In this arbitration, as described above, for example, the round robin system is used. It is obvious that the arbitration can be performed between, for example, the requester A and the requester C, or the requester B and the requester C.

Then in step S8, when the result of the arbitration is the permission of the request from the requester A or B, a GNT_A signal or a GNT_B signal is asserted. If the request from the requester C is permitted, then no process is performed, it is determined in step S9 whether or not the data transfer of the requester whose GNT signal has been asserted has been completed. The monitor is continued if it is determined NO, and the processes in and after step S1 are repeated if it is determined YES.

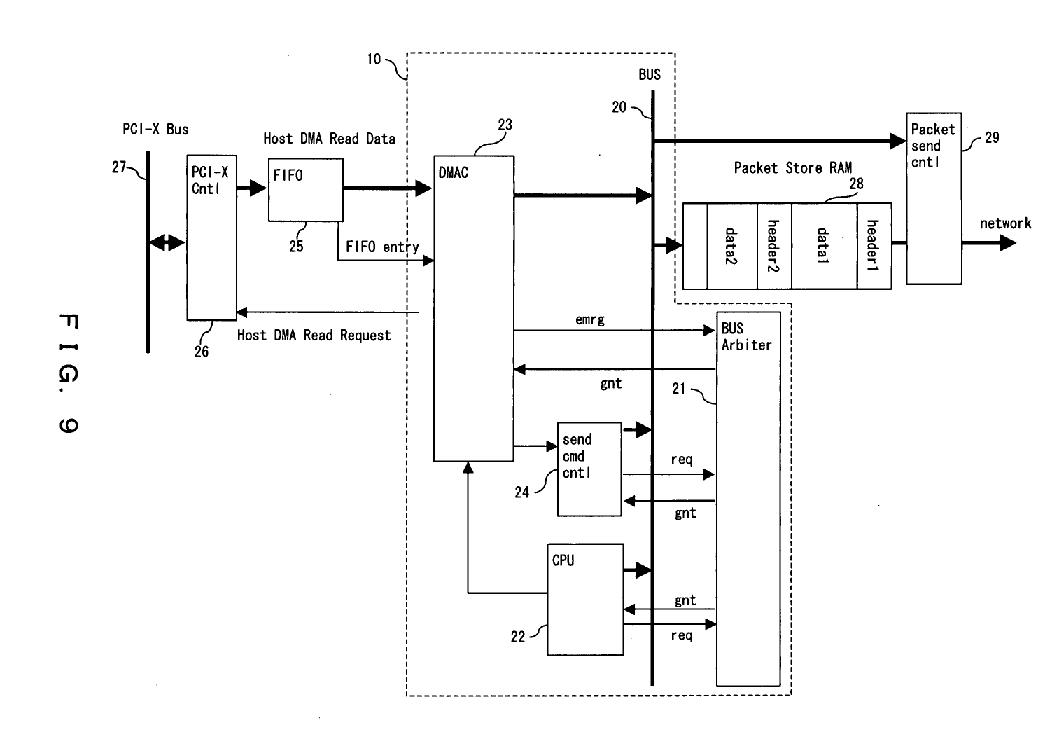

Then, the explanation is given below by referring to the transmission packet generation circuit in the network as a practical example. FIG. 9 shows an example of the configuration of the transmission packet generation and transmission circuit in the network. In FIG. 9, a bus 20, a bus arbiter 21, a CPU 22, a DMA controller 23, and a send cmd cntl (send command contoller) 24 corresponds to the data transfer apparatus 10 shown in FIG. 2.

The DMA controller 23 transfers a packet (payload) data, transferred by a host memory which is not shown in FIG. 9, to a packet store RAM 28 through the bus 20, and corresponds to the requester C shown in FIG. 2. That is, the data in the host memory (host DMA read data) is stored in a FIFO 25 by a PCI-X controller 26 through a PCI-X bus 27 as a high-speed data transmission line in a computer. The DMA controller 23 receives the packet data, and transfers it to the packet store RAM 28.

The CPU 22 and the send cmd cntl 24 correspond to the requesters A and B. The CPU 22 generates a packet header and transfers the packet header to the packet store RAM 28 through the bus 20. The send cmd cntl 24 transfers to a packet send controller 29 a packet transmit command to the network through the bus 20.

A packet is generated and transmitted as follows.
(1) The CPU 22 performs a packet header generating process including network control information such as destination address information, etc., and transfers a generated packet header from the bus 20 to the packet store RAM 28.
(2) The CPU 22 issues a DMA command to the DMAC 23 to store in the packet store RAM 28 the packet payload data in the host memory.
(3) The DMAC 23 issues a Host DMA Memory Read request to the PCI-X Cntl 26.
(4) The PCI-X Cntl 26 reads the Host Memory Data from the PCI-X bus 27, and writes it to the FIFO 25.
(5) The DMAC 23 reads data from the FIFO 25, and transfers packet payload data to the packet store RAM 28 through the bus 20.
(6) The DMAC 23 issues a packet transmit command to the send cmd cntl 24.
(7) The send cmd cntl 24 issues a packet transmit command to the packet send cntl 29 through the bus 20.
(8) The packet send cntl 29 transmits the packet to the network.

The CPU 22 can perform the processes (1) and (2) for the next packet during the processes (3) through (8) after the completion of the processes (1) and (2) above. The DMAC 23 can receive a plurality of DMA commands from the CPU 22, and can perform the process (3) for the next packet without waiting for the completion of the processes (5) and (6) after the process (3) is completed.

The PCI_X protocol enables a split transaction, and the PCI-X Cntl 26 can issue the next request to the PCI-X bus 27 without waiting for the completion of the reception of memory read request data.

In FIG. 9, the bus 20 separately contains an address and data. An address is specified for each cycle. Although a GNT signal is asserted in a cycle in which, for example, a REQ signal is asserted as shown in FIG. 3, it is asserted one cycle after the assertion of the REQ signal in this example. The relationship between the assertion of the REQ signal and the assertion of the GNT signal is not essential in the present embodiment.

A requester other than the DMAC 23 is assumed to continuously assert the REQ signal from the assertion of the REQ signal to the completion of the data transfer, and the maximum burst length for data transfer is not prescribed by the DMAC 23, and the restrictions of the burst length for other requesters are also arbitrarily set. The writing of data from the DMAC 23 to the packet store RAM 28 and the transmission of a command from the send cmd cntl 24 to the packet send controller 29 are discriminated by the address of the bus 20.

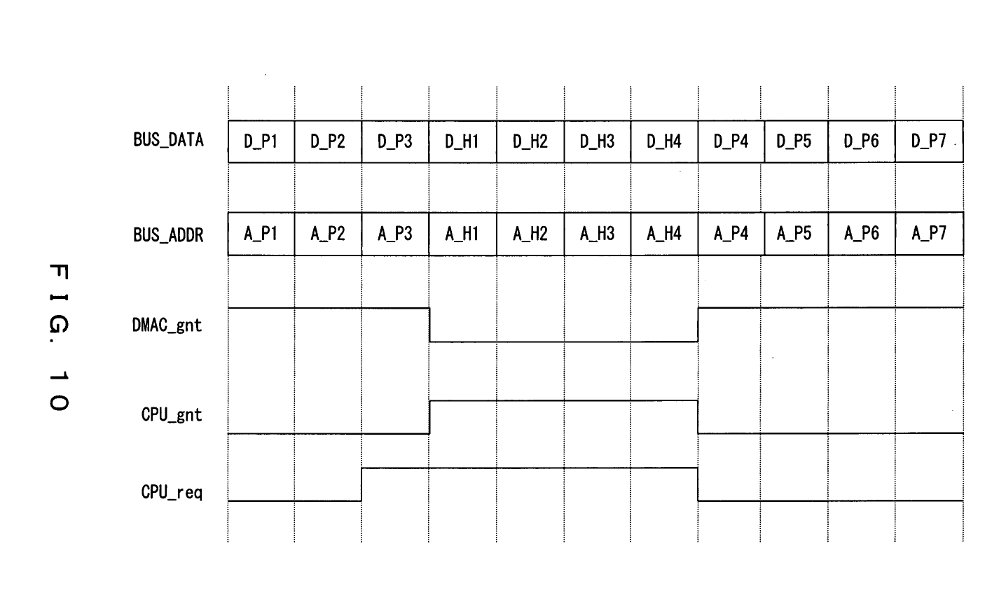

FIG. 10 is a time chart of a practical example of interrupting the data transfer from the DMAC 23 corresponding to a request from the CPU 22. In the time chart shown in FIG. 10, while the DMAC 23 is transferring the packet payload data D_Px to the address A_Px, the CPU 22 transfers the packet header D_Hx to the address A_Hx. When the transfer of the header is completed, the DMAC 23 transfers packet payload data.

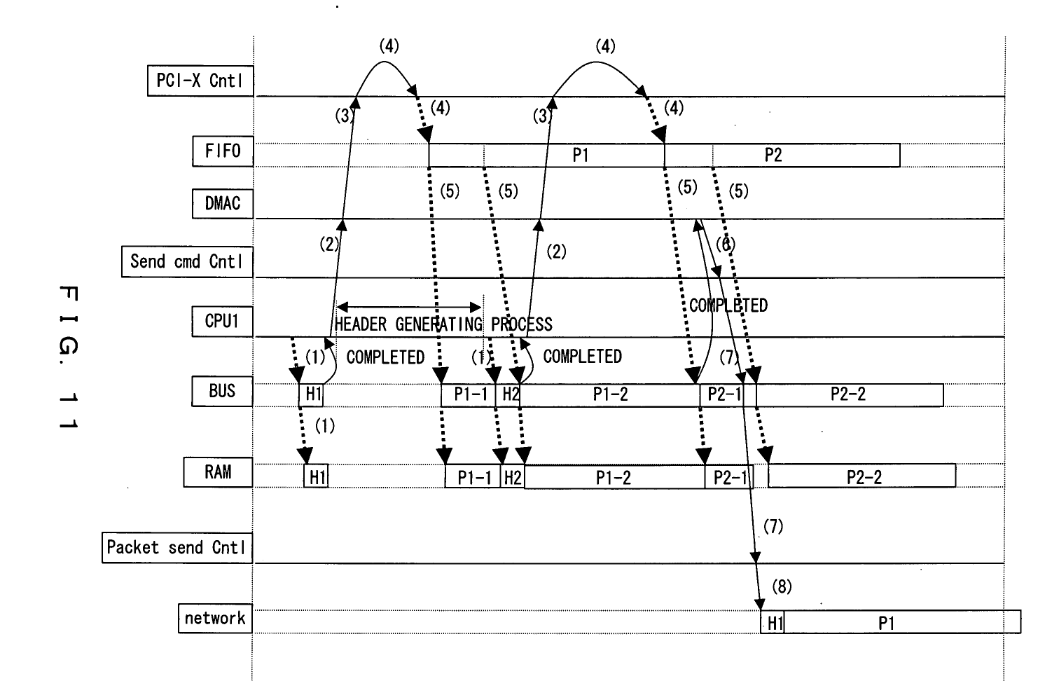

FIG. 11 shows a practical example of a time chart of the process of generating and transmitting two packets in a time-overlapping manner. In FIG. 11, the processes of generating a packet formed by a header H1 and payload data P1 and a packet formed by a header 2 and payload data P2 are performed in a time-overlapping manner.

That is, while the DMAC 23 is transferring the payload data P1 through the bus 20, the header generating process is completed by the CPU 22, and the header H2 can be transferred. In the present embodiment, the DMAC 23 releases the bus 20, and the header H2 is transferred. After the process of generating a header H2 is completed, the response time to the transfer can be shortened, thereby shortening the timing with which a DMA request for requesting the host for the payload data P2 is issued, and continuously performing the data transfer of the payload data P1 and P2.

The DMAC 23 releases the bus 20 while transferring the payload data P2 to the packet store RAM 28, and the send cmd cntl 24 issues a packet transmit command to the packet send controller 29. Thus, the packet store RAM 28 stores a packet header and payload data, and the response time from the time when the packet transmission is enabled to the time when the actual packet transmit command is issued can be shortened, thereby more quickly issuing a packet to the network. The DMAC 23 can occupy the bus while other requesters, that is, the CPU 22 and the send cmd cntl 24, are not using the bus 20, thereby realizing high throughput.

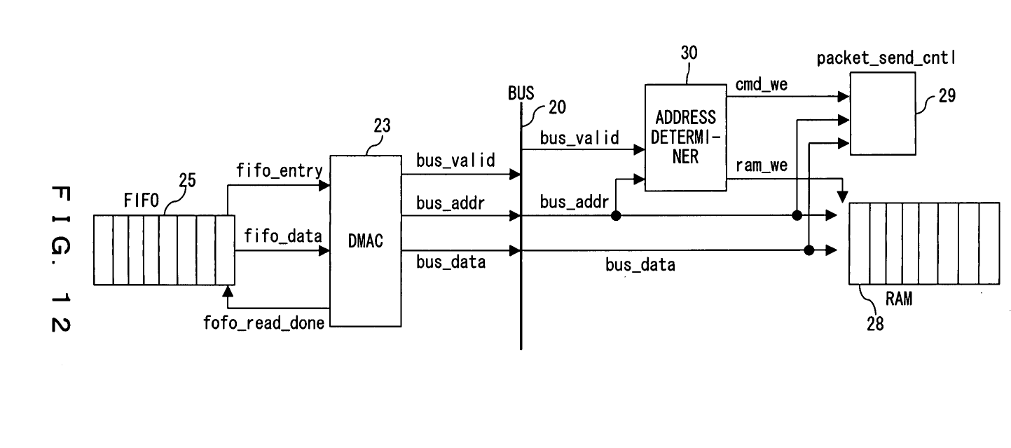

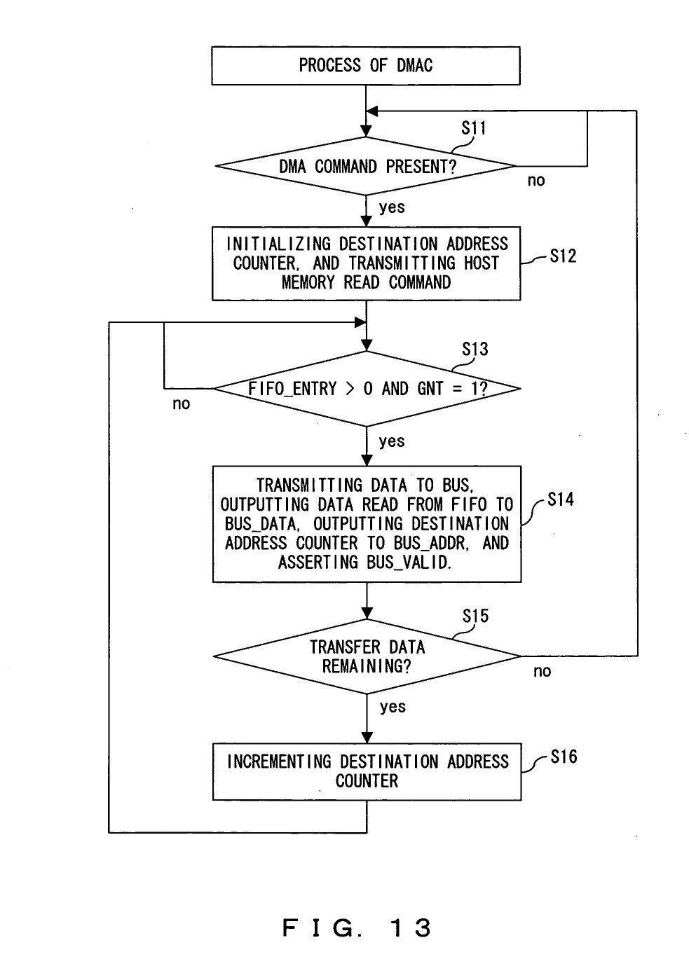

As described above, the DMAC 23 starts data transfer with the timing the GNT signal from the bus arbiter 21 is asserted, and the data transfer is interrupted when the signal is deasserted. The operation is explained by referring to the packet generating and transmitting circuit including the address determiner shown in FIG. 12 and the flowchart of the process shown in FIG. 13.

In FIG. 9, the requester is assumed to output an address to an address bus and data to a data bus, and assert a bus valid signal indicating that the address and data is valid when the GNT signal from the bus arbiter 21 is asserted. Relating to the packet store RAM 28 for receiving data and the packet send controller 29, for example, the address of the packet store RAM 28 is specified according to the signal from the address bus, and the packet data is written at the address. The data bus is directly connected to the packet store RAM 28 and the packet send controller 29. An address determiner 30 asserts a write enable signal ram-we signal to the RAM if the bus valid signal is asserted and the address is in the address range of the RAM. The address determiner 30 also asserts the cmd-we signal indicating that the command is valid (write enable) if the bus valid signal is asserted and the address refers to the packet send controller 29.

FIG. 13 is a flowchart of the process by the DMAC 23. First, in step S11, it is determined whether or not a DMA command, that is, a command from the CPU 22, has been issued. If not, the process of waiting for the command is continued. If yes, a source address, that is, a host memory address, a destination address, that is the address of the packet store RAM 28, and the transfer data size are simultaneously transmitted to the DMAC 23. In response to the command, the DMAC 23 initializes the value of the destination address counter not shown in the attached drawings in step S12 to the specified value of the destination address.

Then, the DMAC 23 specifies the data read from the host memory corresponding to the source address, and the data is stored in the FIFO 25. In the entries of the FIFO 25, the number of the entries storing data is transmitted to the DMAC 23 according to the fifo_entry signal, and the DMAC 23 asserts the fifo_read_done signal each time a piece of entry data is retrieved.

In step S13 shown in FIG. 13, it is determined whether or not the value of the fifo_entry signal is 1 or more, and the GNT signal is asserted. If the conditions are not satisfied, the determination is repeated. If they are satisfied, then the data read from the FIFO 25 is output to the data bus, and the value of the destination address counter is output to the address bus in step S14, and the bus valid signal is asserted. Thus, the packet payload data transmitted from the host is transferred to the packet store RAM 28.

It is determined whether or not there is transfer data remaining in step S15. If not, the processes in and after step S11 are repeated. If yes, the value of the destination address counter is incremented in step S16, and then the processes in and after step S13 are repeated. Thus, the assertion check for the GNT signal is made in step S13 for each bus cycle until the data transfer is completed, thereby realizing the interrupt/resumption of the data transfer, enabling the bus to be released by the DMAC 23 with any timing, and resuming an interrupted data transfer.

Described below in more detail is the assertion of the EMRG signal by the DMAC 23. In FIG. 9, the PCI-X controller 26 writes data to the FIFO 25 without considering the number of entries storing data in the FIFO 25. The DMAC 23 is assumed to be able to issue a host memory read request for the data larger in number of entries of the FIFO 25 to the PCI-X controller 26. When the number of entries storing data in the FIFO 25 exceeds a predetermined value, the DMAC 23 asserts an EMRG signal, and it deasserts the EMRG signal when the number of entries storing data is equal to or smaller than a predetermined value, thereby preventing the overflow of the FIFO 25. To enable a change in the maximum write speed and the maximum read speed for the FIFO 25, the threshold of the number of entries corresponding to the assertion of the EMRG signal and the threshold corresponding to the deassertion can be externally set.

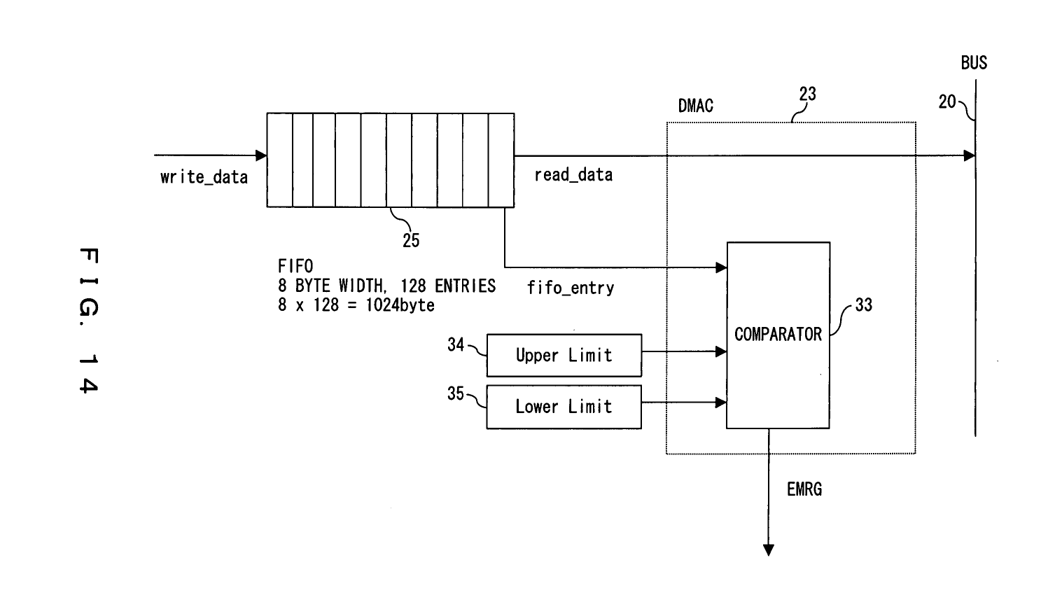

FIG. 14 is an explanatory view of the overflow suppressing system of the FIFO in the packet generating and transmitting circuit. In FIG. 14, the FIFO 25 is assumed to be equipped with 128 entries of 8-byte width, and a total of 1024 bytes of data can be stored. The DMAC 23 issues a 2048-byte host memory read request to the PCI-X controller 26, and the PCI-X controller 26 continuously writes 2048-byte host memory read data to the FIFO 25 without considering the number of empty entries in the FIFO 25. A write and read of the data to the FIFO 25 are performed using the same clock.

The DMAC 23 reads data from the FIFO 25 when the GNT signal is asserted, and outputs the data to the bus 20. When a requester other than the DMAC 23 uses the bus 20, the GNT signal for the DMAC 23 is not asserted, and the DMAC 23 does not read data in the FIFO 25 during the period. If the period in which the GNT signal for the DMAC 23 is not asserted continues 128 cycles or more, there is the possibility of an overflow of the FIFO 25.

A comparator 33 is provided in the DMAC 23, and the comparator 33 asserts the EMRG signal when the fifo-entry value from the FIFO 25 exceeds an upper limit 34, and then deasserts the EMRG signal when the value becomes a lower limit 35 or less. When the largest possible burst length for data transfer by a requester other than the DMAC 23, that is, the CPU 22 and the send cmd cntl 24, is the value for 32 cycles. If the value of the upper limit 34 is, for example, 96, and the value of the lower limit 35 is 64, then the EMRG signal is asserted when the fifo-entry value is 96, and deasserted when value is 64.

Since the largest possible burst length for data transfer of the requester other than the DMAC 23 is the value for 32 cycles, it means that a maximum of 32 cycles are required from the assertion of the EMRG signal to the next arbitration. That is, the GNT signal to the DMAC 23 is asserted within 32 cycles from the assertion of the EMRG signal, and the DMAC 23 continues reading data from the FIFO 25 until the value of fifo-entry reaches 48. Therefore, when the data write clock is equal to the data read clock, the data overflow in the FIFO 25 can be suppressed.

As described above, according to the present invention, when a data transfer request from a requester for performing transfer of a small amount of data is detected, it is prioritized over a data transfer request from a requester for performing transfer of a large amount of data, and obtains a permission to use the bus for the request.

According to the present invention, a transfer of a small amount of data is prioritized over a transfer of a large amount of data, and the transfer of a large amount of data is performed in the period in which the transfer of a small amount of data is not performed, thereby improving data transfer performance.

The present invention is available for an apparatus and all related industries using a data transfer system for allowing any of a plurality of data transfer requests to perform a data transfer through a data transfer path.

1. A data transfer apparatus which arbitrates a plurality of data transfer requests and performs data transfer through a data transfer path based on an arbitration result, comprising:
a first transfer request unit requesting data transfer;
a second transfer request unit requesting data transfer shorter in transfer time than the data transfer of said first transfer request unit; and
a transfer arbitration unit prioritizing a transfer request from said second transfer request unit over the first transfer request when a data transfer request from said second transfer request unit is detected, and allowing said second transfer request unit to perform data transfer through the data transfer path.

2. The apparatus according to claim 1, wherein
when said first transfer request unit outputs an urgent signal indicating that a data transfer request is urgent, said transfer arbitration unit permits the first transfer request to perform data transfer through the data transfer path by priority while the urgent signal is being output.

3. The apparatus according to claim 2, further comprising
a data storage unit storing plural pieces of data to be transferred by said first transfer request unit, wherein
said first transfer request unit outputs the urgent signal when the number of pieces of data stored in said data storage unit is in a predetermined range.

4. The apparatus according to claim 1, wherein
when said first transfer request unit outputs an urgent signal indicating that a data transfer request is urgent, said transfer arbitration unit equally arbitrates the first transfer request and the second transfer request to perform data transfer through the data transfer path based on an arbitration result.

5. The apparatus according to claim 4, wherein
said transfer arbitration unit uses a round robin system in equally performing the arbitration.

6. The apparatus according to claim 4, further comprising
a data storage unit storing plural pieces of data to be transferred by said first transfer request unit;
said first transfer request unit outputs the urgent signal when the number of pieces of data stored in said data storage unit is in a predetermined range.

7. The apparatus according to claim 1, further comprising
a third transfer request unit requesting a data transfer shorter in transfer time than the first transfer request, wherein
said transfer arbitration unit equally arbitrates the second transfer request and the third transfer request, performs data transfer using the data transfer path based on the arbitration result, and allows said first transfer request unit to perform data transfer using a data transfer path after completing data transfer at the second transfer request and the third transfer request.

8. The apparatus according to claim 7, wherein
said transfer arbitration unit uses a round robin system in equally performing the arbitration.

9. A data transfer control program used by a computer to arbitrate a plurality of data transfer requests, and perform data transfer using a data transfer path based on an arbitration result, comprising:
a procedure of detecting a second data transfer request for data transfer shorter in transfer time than a first transfer request; and
a procedure of performing data transfer using the data transfer path in response to the second data transfer request by prioritizing the second data transfer request over the first data transfer request when the second data transfer request is detected.

10. A data transfer control method used by a computer to arbitrate a plurality of data transfer requests, and perform data transfer using a data transfer path based on an arbitration result, comprising:
detecting a second data transfer request for data transfer shorter in transfer time than a first transfer request; and
performing data transfer using the data transfer path in response to the second data transfer request by prioritizing the second data transfer request over the first data transfer request when the second data transfer request is detected.
